(19) United States
(12) Patent Application Publication
(10) Pub. No.: US 2008/0292365 A1
(43) Pub. Date: Nov. 27, 2008

(54) IMAGE FORMING APPARATUS AND DEVELOPING DEVICE

(75) Inventors: Masashi Fujishima, Osaka-shi (JP); Shoichi Sakata, Osaka-shi (JP); Takahisa Nakaue, Osaka-shi (JP); Yukihiro Mori, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 12/123,553

(22) Filed: May 20, 2008

(30) Foreign Application Priority Data
May 25, 2007 (JP) 2007-139455
May 25, 2007 (JP) 2007-139456

(51) Int. Cl. G03G 15/08

(52) U.S. Cl. 399/285

(57) ABSTRACT

An image forming apparatus is characterized in that an absolute value of a difference between a first coefficient of variation in a number distribution of the particle diameter of a toner carried on a developing roller and a second coefficient of variation in a number distribution of the particle diameter of a toner in a two-component developer carried on the magnetic roller is within 5% and an absolute value of a difference between a third coefficient of variation in a number distribution of the particle diameter of a toner of a toner image developed on the outer surface of an image bearing member and the second coefficient of variation is within 6%. With such an image forming apparatus, high-quality images can be stably formed over a long term.

### BACKGROUND OF THE INVENTION

1. Field of the Invention

The present invention relates to an electrophotographic image forming apparatus such as a copier, a printer, a facsimile machine or a complex machine of these, and a developing device provided in this image forming apparatus.

2. Description of the Related Art

A developing device provided in an electrophotographic image forming apparatus causes a toner conveyed by a developing roller to fly toward the surface of a photoconductive drum as an image bearing member where an electrostatic latent image based on an image data is formed, thereby forming a toner image. The image forming apparatus provided with such a developing device transfers the toner image formed on the photoconductive drum to a recording medium such as a sheet and, then, fixes this transferred toner image to the recording medium by heating it by a fixing device. In this way, the image forming apparatus forms an image based on the image data on the recording medium (see, for example, U.S. Pat. No. 3,929,098, document D1).

Among such image forming apparatuses, a tandem image forming apparatus in which a plurality of image forming units corresponding to the colors of toners used are arranged side by side and color images are formed in synchronism with the movement of an intermediate transfer belt to be superimposed on the intermediate transfer belt is known as the one with a high-speed performance. Despite its good high-speed performance, the image forming apparatus of this type has a problem of a larger size since the image forming units of the respective colors have to be arranged side by side. As a countermeasure, there has been proposed a small-size tandem image forming apparatus in which intervals between photoconductive drums are narrowed and smaller image forming units are arranged.

For example, a touch-down developing device is used as a developing device provided in such a small-size tandem image forming apparatus. The touch-down developing device uses a two-component developer containing a toner and a carrier as a developer and develops an image as described below. The touch-down developing device first transfers the toner of the two-component developer from a magnetic roller to a developing roller by applying a toner supply bias voltage to the magnetic roller carrying and conveying the two-component developer and, then, causes the toner on the developing roller to fly to a photoconductor surface to develop an image by applying a development bias voltage to the developing roller.

A developing device for applying a superposed voltage obtained by superposing an alternating-current component of a rectangular waveform on a direct-current component to a developing roller as a development bias voltage and applying a direct-current voltage to a magnetic roller as a toner supply bias voltage can be, for example, cited as a conventional touch-down developing device (Japanese Unexamined Patent Publication No. 2003-21961: document D2, Japanese Unexamined Patent Publication No. 2003-21966: document D3 and Japanese Unexamined Patent Publication No. 2003-280357: document D4).

According to the developing devices of documents D2 to D4, it is disclosed that a phenomenon, in which a part of a developed image appears as a ghost during the next developing operation, a so-called hysteresis, an occurrence of fogging and the like can be suppressed by optimizing a potential difference between the direct-current component of the development bias voltage and the toner supply bias voltage, the duty ratio of the alternating-current component of the development bias voltage and the like. This is thought to be due to the fact that a force can be exerted in a direction to pull the toner unnecessary for image development back from the photoconductor surface by superposing the alternating-current component on the direct-current component to obtain the development bias voltage.

However, in such a developing device, a phenomenon, in which a toner having specific particle diameter are selectively transferred and preferentially consumed, a so-called selective development has occurred. Thus, if image formation is performed using such a developing device, the particle diameter distribution of the toner in the developing device changes, wherefore it was impossible to exhibit a stable development characteristic for a long time. If an attempt is made to transfer the toner to the photoconductor regardless of the particle diameter of the toner by forming a strong development electric field between the photoconductor and the developing roller in order to suppress the selective transfer of the toner, the toner supply bias voltage to be applied to the magnetic roller has to be weakened because of a relationship with the development bias voltage to be applied to the developing roller. Thus, a force for separating the toner, which was not used for image development, from the surface of the developing roller becomes weaker and the toner supply from the magnetic roller to the developing roller becomes insufficient, wherefore it has been difficult to suppress the hysteresis.

There is also known a developing device for applying a superposed voltage obtained by superposing an alternating-current component of a rectangular waveform on a direct-current component to a developing roller as a development bias voltage and applying a superposed voltage obtained by superposing an alternating-current component of a rectangular waveform having the same frequency as the alternating-current component of the development bias voltage, a phase opposite to that of this alternating-current component and a duty ratio inverted from that of this alternating-current component on a direct-current component to a magnetic roller as a toner supply bias voltage (see, Japanese Unexamined Patent Publication No. 2005-242281: document D5).

According to the developing device disclosed in document D5, it is disclosed that a voltage for transferring the toner from the magnetic roller to the developing roller (voltage between the developing roller and the magnetic roller) can be increased without increasing a voltage between the photoconductor and the developing roller (development voltage) by superposing the alternating-current component corresponding on that of the development bias voltage to obtain the toner supply bias voltage.

However, such a developing device has to control the voltage for transferring the toner from the magnetic roller to the developing roller based on the relationship of the development bias voltage and the toner supply bias voltage as described in detail later and, hence, could not sufficiently suppress the selective transfer of the toner. Further, development efficiency decreases unless the phases of the development bias voltage and the toner supply bias voltage are rigorously controlled.

There is also known a developing device constructed such that the charge number distribution of toner carried on a developing roller and that of toner contained in a two-component developer carried on a magnetic roller differ (see, Japanese Unexamined Patent Publication No. 2001-272857: document D6).

That the charge number distribution of the toner carried on the developing roller and that of the toner contained in the two-component developer carried on the magnetic roller differ as in the developing device disclosed in document D6 indicates that the toner of the two-component developer on the magnetic roller selectively transfers to the developing roller. Therefore, this developing device neither focuses attention on the suppression of the selective transfer of the toner nor aims to perform a stable image formation over a long term.

### SUMMARY OF THE INVENTION

An object of the present invention is to provide an image forming apparatus capable of stably forming high-quality images over a long term. Another object of the present invention is to provide an developing device having a stable development performance over a long term.

In order to accomplish these objects, one aspect of the present invention is directed to an image forming apparatus, comprising an image bearing member to have an electrostatic latent image formed thereon; a developing roller arranged to face the image bearing member and adapted to carry and convey a toner on the outer surface thereof; a magnetic roller for carrying and conveying a two-component developer containing a toner and a carrier; a first bias voltage applying device for applying a toner supply bias voltage to the magnetic roller to transfer the toner in the two-component developer conveyed by the magnetic roller to the outer surface of the developing roller; and a second bias voltage applying device for applying a development bias voltage to the developing roller to cause the toner conveyed by the developing roller to fly to the outer surface of the image bearing member, thereby developing the electrostatic latent image formed beforehand on the outer surface of the image bearing member into a toner image for the formation of an image, wherein an absolute value of a difference between a first coefficient of variation in a number distribution of the particle diameter of the toner carried on the developing roller and a second coefficient of variation in a number distribution of the particle diameter of the toner in the two-component developer carried on the magnetic roller is within 5%; and an absolute value of a difference between a third coefficient of variation in a number distribution of the particle diameter of the toner of the toner image developed on the outer surface of the image bearing member and the second coefficient of variation is within 6%.

Another aspect of the invention is directed to a developing device, comprising a developing roller arranged to face an image bearing member to have an electrostatic latent image formed thereon and adapted to carry and convey a toner on the outer surface thereof; a magnetic roller for carrying and conveying a two-component developer containing a toner and a carrier; a first bias voltage applying device for applying a toner supply bias voltage to the magnetic roller to transfer the toner in the two-component developer conveyed by the magnetic roller to the outer surface of the developing roller; and a second bias voltage applying device for applying a development bias voltage to the developing roller to cause the toner conveyed by the developing roller to fly to the outer surface of the image bearing member, thereby developing the electrostatic latent image formed beforehand on the outer surface of the image bearing member into a toner image, wherein an absolute value of a difference between a first coefficient of variation in a number distribution of the particle diameter of the toner carried on the developing roller and a second coefficient of variation in a number distribution of the particle diameter of the toner in the two-component developer carried on the magnetic roller is within 5%.

Still another aspect of the present invention is directed to a developing device, comprising a developing roller arranged to face an image bearing member and adapted to carry and convey a toner on the outer surface thereof; a magnetic roller for carrying and conveying a two-component developer containing a toner and a carrier; a first bias voltage applying device for applying a toner supply bias voltage to the magnetic roller to transfer the toner in the two-component developer conveyed by the magnetic roller to the outer surface of the developing roller; and a second bias voltage applying device for applying a development bias voltage to the developing roller to cause the toner conveyed by the developing roller to fly to the outer surface of the image bearing member, thereby developing the electrostatic latent image formed beforehand on the outer surface of the image bearing member into a toner image, wherein an absolute value of a difference between a third coefficient of variation in a number distribution of the particle diameter of the toner of the toner image developed on the outer surface of the image bearing member and a second coefficient of variation in a number distribution of the particle diameter of the toner in the two-component developer carried on the magnetic roller is within 6%.

These and other objects, features, aspects and advantages of the present invention will become more apparent upon a reading of the following detailed description and accompanying drawings.

### BRIEF DESCRIPTION OF THE DRAWINGS

FIG. 1 is a schematic section showing the entire construction of a color printer provided with a developing device according to one embodiment of the invention,

FIG. 2 is a schematic section showing the construction of the developing device according to the embodiment of the invention,

FIG. 3 is a schematic diagram showing image development by the developing device shown in FIG. 2,

FIG. 4A is a waveform chart showing an exemplary waveform of a toner supply bias voltage to be applied to the developing device shown in FIG. 2,

FIG. 4B is a waveform chart showing an exemplary waveform of a development bias voltage to be applied to the developing device shown in FIG. 2,

FIG. 5 is a schematic diagram showing the construction of a developing device according to a comparative embodiment,

FIG. 6 is a waveform chart showing exemplary waveforms of voltages to be applied to the developing device shown in FIG. 5,

FIG. 7 is a waveform chart showing a case where the phases of a development bias voltage and a toner supply bias voltage deviate from preferred ones in the developing device shown in FIG. 5,

FIG. 8 is a diagram showing an exemplary evaluation image used for the evaluation of image density ID,

FIG. 9A is a diagram showing an exemplary evaluation image used for ghost evaluation, and

FIG. 9B is a diagram showing an exemplary output image when a ghost occurred.

### DETAILED DESCRIPTION OF THE PREFERRED EMBODIMENTS

Hereinafter, an image forming apparatus and a developing device provided in the image forming apparatus according to one embodiment of the present invention are described in detail with reference to the accompanying drawings.

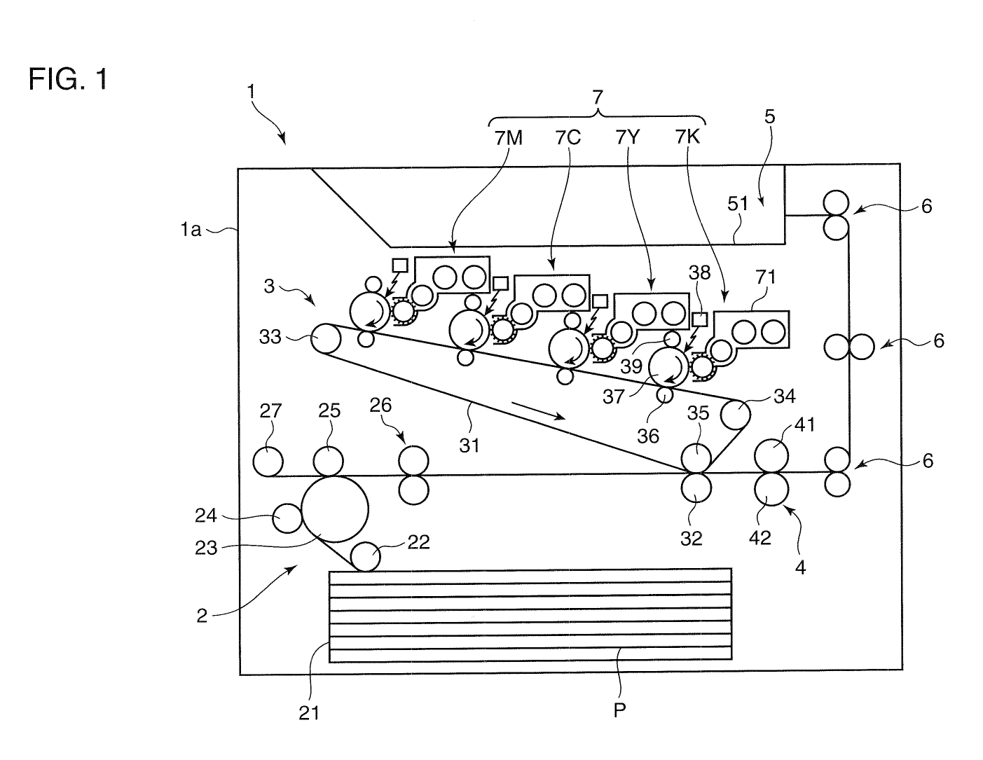

First of all, a color printer as an example of the image forming apparatus according to the embodiment of the present invention is described with reference to FIG. 1. FIG. 1 is a schematic section showing the entire construction of the color printer as an example of the image forming apparatus according to the embodiment of the present invention.

As shown in FIG. 1, this color printer 1 includes a box-shaped apparatus main body 1a. In this apparatus main body 1a are provided a sheet feeding unit 2 for feeding a sheet P, an image forming assembly 3 for transferring a toner image based on an image data or the like to the sheet P while conveying the sheet P fed from the sheet feeding unit 2, and a fixing unit 4 for applying a fixing process to fix the toner image transferred onto the sheet P in the image forming assembly 3, but not fixed yet to the sheet P. Further, a discharge unit 5 for discharging the sheet P having the toner image fixed thereto in the fixing unit 4 is provided in the top surface of the apparatus main body 1a.

The sheet feeding unit 2 includes a sheet cassette 21, a pickup roller 22, feed rollers 23, 24 and 25, and registration rollers 26. The sheet cassette 21 is detachable from the apparatus main body la and stores sheets P of the respective sizes. The pickup roller 22 is disposed at a left upper position of the sheet cassette 21 shown in FIG. 1 for dispensing the sheets P stored in the sheet cassette 21 one by one. The feed rollers 23, 24 and 25 convey the sheet P dispensed by the pickup roller 22 to a sheet conveyance path. The registration rollers 26 feed the sheet P conveyed to the sheet conveyance path by the feed rollers 23, 24 and 25 to the image forming assembly 3 at a specified timing after temporarily keeping the sheet P on standby.

The sheet feeding unit 2 further includes an unillustrated manual feed tray to be attached to the left surface of the apparatus main body 1a shown in FIG. 1 and a pickup roller 27. This pickup roller 27 dispenses a sheet P placed on the manual feed tray. The sheet P dispensed by the pickup roller 27 is fed to the sheet conveyance path by the feed rollers 23, 25 and conveyed to the image forming assembly 3 at a specified timing by the registration rollers 26.

The image forming assembly 3 includes image forming units 7, an intermediate transfer belt 31 and a second transfer roller 32. The image forming units 7 form toner images based on an image data electronically transmitted from a computer or the like. The intermediate transfer belt 31 has the toner images formed by the image forming units 7 primarily transferred to the outer surface (contact surface) thereof. The secondary transfer roller 32 secondarily transfers the toner images on the intermediate transfer belt 31 to the sheet P fed from the sheet feeding unit 21.

The image forming units 7 include a black unit 7K, a yellow unit 7Y, a cyan unit 7C and a magenta unit 7M successively arranged from an upstream side (right side in FIG. 1) toward a downstream side. In each of the units 7K, 7Y, 7C and 7M, a photoconductive drum 37 as an image bearing member is so arranged at a central position as to be rotatable in a direction of arrow (clockwise direction). A charger 39, an exposure device 38, a developing device 71, unillustrated cleaning device, charge neutralizer and the like are successively arranged around the photoconductive drum 37 from an upstream side in a rotating direction.

The charger 39 uniformly charges the circumferential surface of the photoconductive drum 37 rotating in the direction of arrow. For example, corotron and scorotron chargers adopting a noncontact discharge method, charging rollers and charging brushes adopting a contact method and the like can be used as the charger 39. The exposure device 38 is a so-called laser scanning unit and irradiates the circumferential surface of the photoconductive drum 37 uniformly charged by the charger 39 with a laser beam based on an image data inputted from an image reader or the like to form an electrostatic latent image based on the image data on the photoconductive drum 37. The developing device 71 forms a toner image based on the image data by supplying toner to the circumferential surface of the photoconductive drum 37 formed with the electrostatic latent image. This toner image is primarily transferred to the intermediate transfer belt 31. The cleaning device cleans the toner residual on the circumferential surface of the photoconductive drum 37 after the primary transfer of the toner image to the intermediate transfer belt 31 is completed. The charge neutralizer neutralizes the circumferential surface of the photoconductive drum 37 after the completion of the primary transfer. The photoconductive drum 37 cleaned by the cleaning device and the charge neutralizer has the circumferential surface thereof charged again by the charger 39 for a new primary transfer.

The intermediate transfer belt 31 is a rotary body in the form of an endless belt and is mounted on a plurality of rollers including a drive roller 33, a driven roller 34, a backup roller 35 and primary transfer rollers 36 such that the outer surface (contact surface) thereof touch the circumferential surfaces of the respective photoconductive drums 37. The intermediate transfer belt 31 is constructed to be endlessly rotated by the plurality of rollers while being pressed against the photoconductive drums 37 by the primary transfer rollers 36 opposed to the respective photoconductive drums 37. The drive roller 33 is drivingly rotated by a driving source such as a stepping motor to give a driving force for the endless rotation of the intermediate transfer belt 31. The driven roller 34, the backup roller 35 and the primary transfer rollers 36 are rotatably disposed and are driven according to the endless rotation of the intermediate transfer belt 31. These rollers 34, 35 and 36 are driven to rotate via the intermediate transfer belt 31 according to the main rotation of the drive roller 33, and support the intermediate transfer belt 31.

The primary transfer rollers 36 apply primary transfer bias voltages (voltages having a polarity opposite to the charging polarity of the toner) to the intermediate transfer belt 31. By doing so, the toner images formed on the respective photoconductive drums 37 are successively primarily transferred in a superimposed manner to the intermediate transfer belt 31 turning in a direction of arrow (counterclockwise direction) by the driving of the drive roller 33 between the respective photoconductive drums 37 and the primary transfer rollers 36.

The secondary transfer roller 32 applies a secondary transfer bias voltage (voltage having a polarity opposite to the charging polarity of the toner) to the sheet P. By doing so, the superimposed toner image primarily transferred to the intermediate transfer belt 31 is transferred to the sheet P between the secondary transfer roller 32 and the backup roller 35, whereby the toner image (color transfer image), which is not fixed yet, is transferred to the sheet P.

The fixing unit 4 applies a fixing process to the transfer image transferred to the sheet P in the image forming assembly 3 and includes a heating roller 41 and a pressure roller 42. The heating roller 41 is heated by an electric heating element. The pressure roller 42 is opposed to the heating roller 41 and the circumferential surface thereof is pressed into contact with that of the heating roller 41.

The transfer image transferred to the sheet P by the secondary transfer roller 32 in the image forming assembly 3 is fixed to the sheet P by the heat fixing process performed when the sheet P is passed between the heating roller 41 and the pressure roller 42. The sheet P having the fixing process applied thereto is discharged to the discharge unit 5. In the color printer 1 of this embodiment, conveyance rollers 6 are arranged at a specified position between the fixing unit 4 and the discharge unit 5.

The discharge unit 5 is formed by recessing the top part of the apparatus main body 1a of the color printer 1, and a discharge tray 51 for receiving the discharged sheet P is formed at the bottom of this recessed portion.

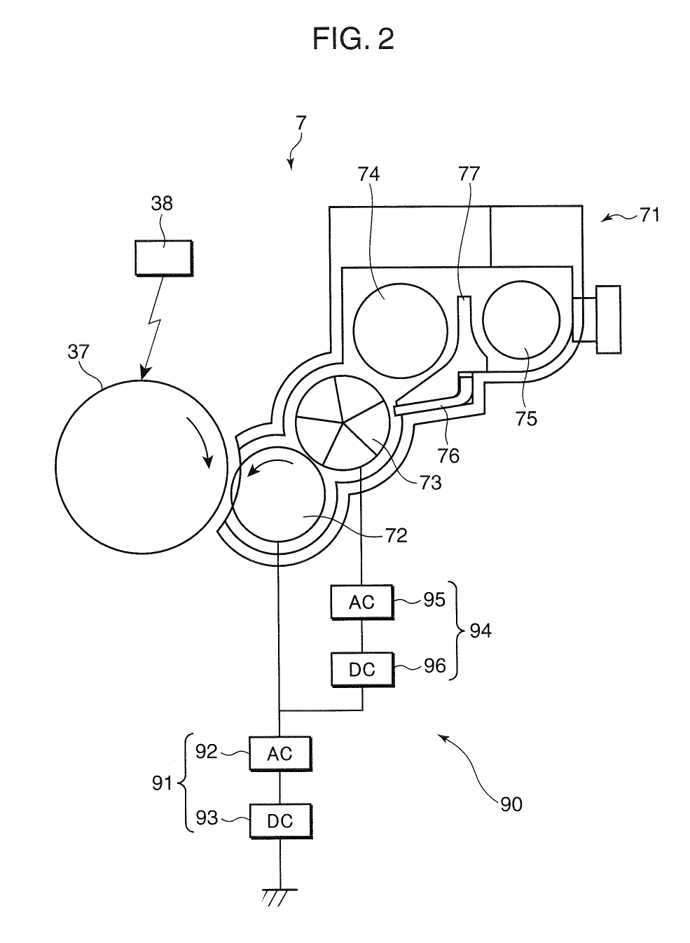

Next, the construction of the developing device 71 provided in the color printer 1 according to the embodiment of the present invention is described. FIG. 2 is a schematic section showing the construction of the developing device 71 according to the embodiment of the present invention, wherein the periphery of the developing device 71 provided in the color printer 1 shown in FIG. 1 is enlargedly shown.

The developing device 71 includes a developing roller 72, a magnetic roller 73, a paddle mixer 74, an agitating mixer 75, a restricting blade 76, a partition plate 77 and voltage applying means 90.

The developing roller 72 develops an electrostatic latent image (image development) formed beforehand on the circumferential surface of the photoconductive drum 37 into a toner image by carrying and conveying the toner on the outer surface. The developing roller 72 has a built-in magnet so as to form a magnetic pole at a position facing the magnetic roller 73. The magnetic roller 73 attracts the two-component developer by a magnet arranged inside to form a magnetic brush, thereby supplying the toner to the developing roller 72. The magnetic brush formed between the developing roller 72 and the magnetic roller 73 is robust since the magnet is built in the developing roller 72. Thus, this magnetic brush can more efficiently release the toner residual on the developing roller 72 without being used for image development, wherefore a hysteresis and an occurrence of fogging can be more suppressed and a high development performance can be exhibited. It should be noted that a roller having a diameter of 20 mm is, for example, used as the developing roller 72 and a roller having a diameter of 25 mm is, for example, used as the magnetic roller 73.

The paddle mixer 74 and the agitating mixer 75 have spiral fins and charge the toner by agitating the two-component developer in opposite directions while conveying it. The paddle mixer 74 supplies the two-component developer containing the charged toner and the carrier to the magnetic roller 73. The restricting blade 76 restricts the thickness of the magnetic brush formed on the magnetic roller 73. The partition plate 77 is disposed between the paddle mixer 74 and the agitating mixer 75 and allows the two-component developer to freely pass at the outer sides of the opposite ends of the partition plate 77.

The voltage applying means 90 includes a plurality of power supplies for applying voltages as described later to the developing roller 72 and the magnetic roller 73. The voltage applying means 90 also includes development bias voltage applying means 91 (corresponding to a second bias voltage applying device) for applying a development bias voltage to the developing roller 72 and the toner supply bias voltage applying means 94 (corresponding to a first bias voltage applying device) for applying a toner supply bias voltage to the magnetic roller 73. The toner supply bias voltage applying means 94 applies the toner supply bias voltage using the development bias voltage applied by the development bias voltage applying means 91 as a basis. In other words, the voltage applying means 90 superposes the toner supply bias voltage on the development bias voltage.

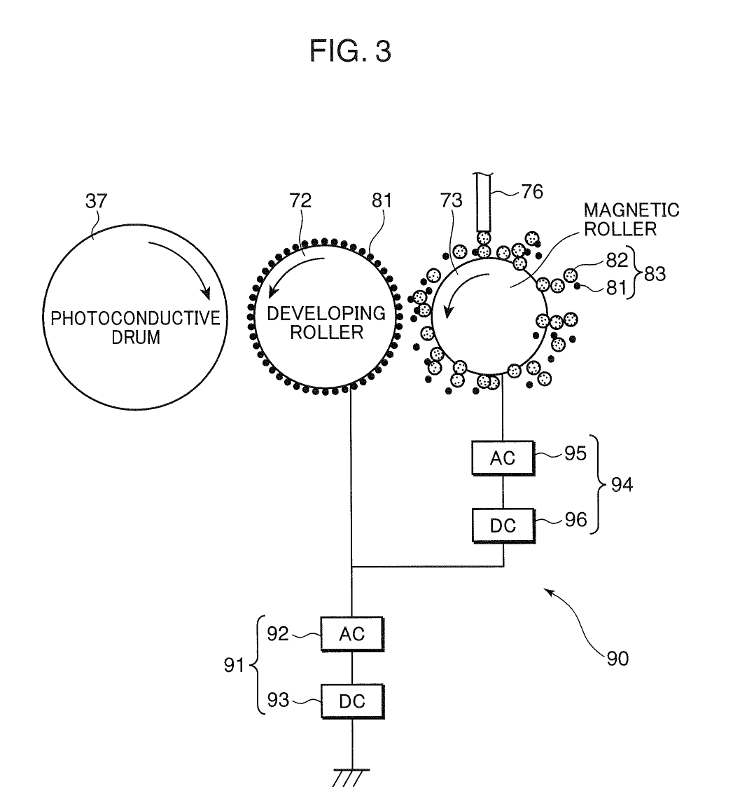

FIG. 3 is a schematic diagram showing image development by the developing device 71, wherein the positional relationship of the photoconductive drum 37, the developing roller 72, the magnetic roller 73 and the restricting blade 76 differs from the one shown in FIG. 2.

A two-component developer 83 containing a toner 81 charged by the paddle mixer 74 and the agitating mixer 75 and a carrier 82 is supplied to the magnetic roller 73. The two-component developer 83 supplied to the magnetic roller 73 is formed into a magnetic brush by the magnet provided in the magnetic roller 73. The magnetic brush is conveyed by the rotation of a sleeve on the outer surface of the magnetic roller 73. The magnetic brush has the thickness thereof restricted upon passing between the restricting blade 76 and the magnetic roller 73. A potential difference is generated between the developing roller 72 and the magnetic roller 73 by the voltages applied by the voltage applying means 90. Thus, when the magnetic brush having the thickness restricted moves to the vicinity of the developing roller 72, only the charged toner 81 transfers to the developing roller 72 due to this potential difference. The toner 81 transferred to the developing roller 72 becomes a uniform toner layer. It should be noted that the potential difference between the developing roller 72 and the magnetic roller 73 depends on the toner supply bias voltage applied by the toner supply bias voltage applying means 94 since the toner supply bias voltage is superposed on the development bias voltage as described above.

A potential difference is generated also between the photoconductive drum 37 and the developing roller 72 by the voltage applying means 90. Thus, the toner 81 on the developing roller 72 transfers to the photoconductive drum 37 due to this potential difference upon moving to the vicinity of the photoconductive drum 37, whereby image development is performed based on the electrostatic latent image formed on the photoconductive drum 37. It should be noted that the potential difference between the photoconductive drum 37 and the developing roller 72 depends on the development bias voltage applied by the development bias voltage applying means 91.

As described above, the developing device 71 can develop an image by applying the development bias voltage and the toner supply bias voltage by means of the voltage applying means 90 in the above manner.

In the developing device 71, the relationship of a coefficient of variation [CV(slv)] (corresponding to a first coefficient of variation) in the number distribution of the particle diameter of the toner carried on the developing roller 72, a coefficient of variation [CV(mag)] (corresponding to a second coefficient of variation) in the number distribution of the particle diameter of the toner of the two-component developer carried on the magnetic roller 73 and a coefficient of variation [CV(drum)] (corresponding to a third coefficient of variation) in the number distribution of the particle diameter of the toner of the toner image developed on the circumferential surface of the photoconductive drum 37 is as follows. Specifically, an absolute value of a difference between CV(slv) and CV(mag) is within 5% and that of a difference between CV(drum) and CV(mag) is within 6%.

If the absolute value of the difference between CV(slv) and CV(mag) exceeds 5% or the absolute value of the difference between CV(drum) and CV(mag) exceeds 6%, the selective transfer of the toner is significant and problems such as an image density defect occurs after making about 1000 print outputs. By setting the absolute value of the difference between CV(slv) and CV(mag) and the absolute value of the difference between CV(drum) and CV(mag) within the above ranges, a toner having specified particle diameter out of the toner of the two-component developer carried on the magnetic roller 73 are less likely to preferentially transfer to the developing roller 72, whereby the selective transfer of the toner is suppressed between the magnetic roller 73 and the developing roller 72.

The coefficient of variation (CV) is an indicator of the uniformity of the particle diameters (diameters) of a particle product (sharpness of a particle diameter distribution) and a ratio of a standard deviation to an average particle diameter. The larger the CV is, the broader the particle size distribution becomes. The smaller the CV is, the sharper the particle size distribution becomes. Here, the coefficient of variation in the number distribution of the particle diameter of the toner is a value obtained by dividing the standard deviation of the particle diameter of the toner by the average particle diameter of the toner and is calculated by the following equation (1).

CV (%)=standard deviation÷average particle diameter×100 (1)

The absolute value of the difference between CV(drum) and CV(slv) is preferably within 3%. If this difference is too large, the selective transfer of the toner is significant and problems such as an image density defect tend to occur if printing is performed for a long time. If the difference between CV(drum) and CV(slv) is small, a toner having the specified particle diameter out of the toner carried on the developing roller 72 are less likely to preferentially transfer to the photoconductive drum 37, wherefore the selective transfer of the toner can be suppressed between the developing roller 72 and the photoconductive drum 37.

In order to suppress the selective transfer of the toner between the magnetic roller 73 and the developing roller 72, the potential difference between the developing roller 72 and the magnetic roller 73 needs to be controlled. In the developing device 71, the toner supply bias voltage applied by the toner supply bias voltage applying means 94 is, for example, controlled to a voltage as described below.

Further, in order to suppress the selective transfer of the toner between the developing roller 72 and the photoconductive drum 37, the potential difference between the photoconductive drum 37 and the developing roller 72 needs to be controlled. In the developing device 71, the development bias voltage applied by the development bias voltage applying means 91 is, for example, controlled to a voltage as described below.

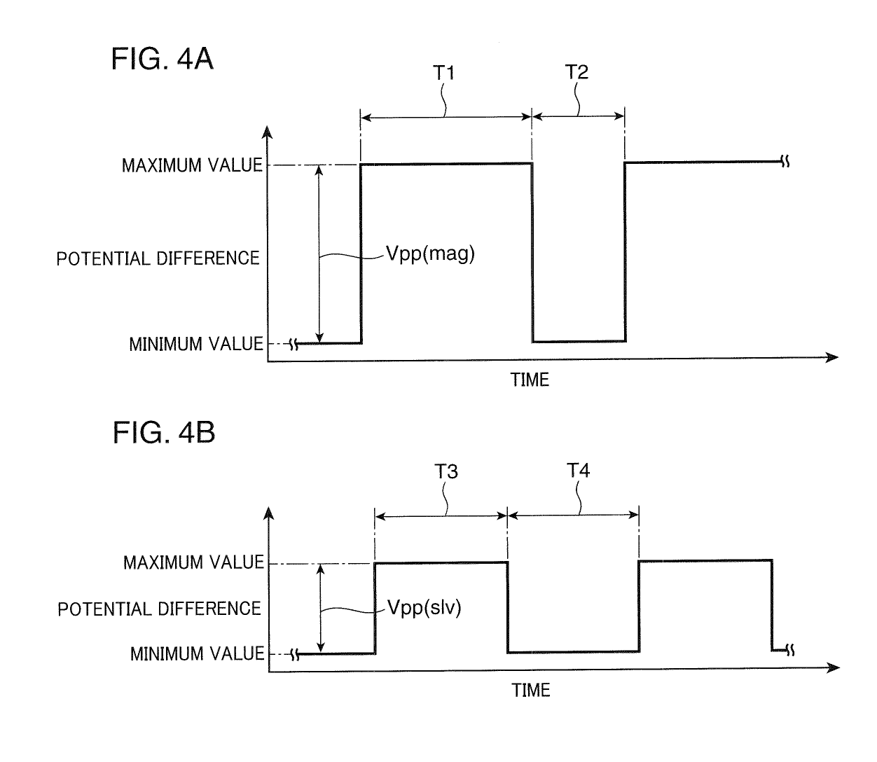

The toner supply bias voltage applied by the toner supply bias voltage applying means 94 and the development bias voltage applied by the development bias voltage applying means 91 are described. FIG. 4A is a waveform chart showing an exemplary waveform of the toner supply bias voltage to be applied to the developing device 71, and FIG. 4B is a waveform chart showing an exemplary waveform of the development bias voltage to be applied to the developing device 71.

The toner supply bias voltage applying means 94 includes an alternating-current power supply 95 for applying an alternating-current voltage and a direct-current power supply 96 for applying a direct-current voltage. The toner supply bias voltage applied by the toner supply bias voltage applying means 94 is preferably a voltage as described below. A direct-current voltage [Vdc(mag)] applied by the direct-current power supply 96 is preferably 100 to 450 V although it differs depending on the resistance of the developer and a rotation speed difference (circumferential speed difference) between the developing roller 72 and the magnetic roller 73. The thin layer of the toner formed on the developing roller 72 tends to become thinner if this direct-current voltage is too low, whereas the toner layer tends to become thicker if it is too high. A peak-to-peak value [Vpp(mag)] of the alternating-current voltage applied by the alternating-current power supply 95 is preferably 0.5 to 5.0 kV and is, for example, set to 1.6 kV or 2.8 kV. It should be noted that Vpp(mag) corresponds to a difference between the maximum and minimum values of the toner supply bias voltage shown in FIG. 4A. A frequency [f(mag)] of the alternating-current voltage applied by the alternating-current power supply 95 is preferably 1 to 6 kHz, more preferably 2.5 kHz or higher and is, for example, set to 2.7 kHz. A positive duty ratio [Duty(mag)] of the alternating-current voltage applied by the alternating-current power supply 95 is preferably 40 to 70%, more preferably 60% or higher. It should be noted that Duty(mag) is a ratio of a period T1 during which a voltage for transferring the toner from the magnetic roller 73 to the developing roller 72 is applied to the sum of the period T1 and a period T2 during which a voltage for pulling the toner from the developing roller 72 back to the magnetic roller 73 is applied.

The development bias voltage applying means 91 includes an alternating-current power supply 92 for applying an alternating-current voltage and a direct-current power supply 93 for applying a direct-current voltage. The development bias voltage applied by the development bias voltage applying means 91 is preferably a voltage as described below. A direct-current voltage [Vdc(slv)] applied by the direct-current power supply 93 is preferably 400 V or lower, more preferably 300 V or lower although it differs depending on a rotation speed difference (circumferential speed difference) between the photoconductive drum 37 and the developing roller 72, and is, for example, set to 300 V. Such voltage setting is preferable since the toner residual on the photoconductive drum 37 without being transferred to the intermediate transfer belt 31 can be easily removed, a hysteresis is more unlikely to occur and the action of a strong electric field on the toner can be prevented. A peak-to-peak value [Vpp(slv)] of the alternating-current voltage applied by the alternating-current power supply 92 is preferably 0.2 to 2 kV and is, for example, set to 1.6 kV. It should be noted that Vpp(slv) corresponds to a difference between the maximum and minimum values of the development bias voltage shown in FIG. 4B. A frequency [f(slv)] of the alternating-current voltage applied by the alternating-current power supply 92 is preferably 1 to 4 kHz and is, for example, set to 2.7 kHz. A positive duty ratio [Duty(slv)] of the alternating-current voltage applied by the alternating-current power supply 92 is preferably 35 to 65%, more preferably 40% or higher. It should be noted that Duty(slv) is a ratio of a period T3 during which a voltage for transferring the toner from the developing roller 72 to the photoconductive drum 37 is applied to the sum of the period T3 and a period T4 during which a voltage for pulling the toner from the photoconductive drum 37 back to the developing roller 72 is applied.

The toner supply bias voltage and the development bias voltage preferably have the following relationship. Vpp(mag) is preferably larger than Vpp(slv). Since the potential difference between the developing roller 72 and the magnetic roller 73 depends only on the toner supply bias voltage, it is possible to smoothly transfer the toner carried on the developing roller 72 to the magnetic roller 73 and the toner of the two-component developer carried on the magnetic roller 73 to the developing roller 72 by setting Vpp(mag) larger than Vpp(slv). Therefore, the selective transfer of the toner between the magnetic roller 73 and the developing roller 72 can be more suppressed.

Further, the sum of Duty(mag) and Duty(slv) is preferably larger than 100. By setting so, both the period during which the toner supply bias voltage is applied to transfer the toner of the two-component developer on the magnetic roller 73 to the developing roller 72 and the period during which the development bias voltage is applied to transfer the toner on the developing roller 72 to the photoconductive drum 37 can be extended. Since the toner can be effectively transferred, the selective transfer of the toner can be more suppressed and images with higher quality can be formed.

Furthermore, Duty(mag) is preferably larger than Duty(slv). By setting so, the toner of the two-component developer carried on the magnetic roller 73 can be smoothly transferred, wherefore the selective transfer of the toner between the magnetic roller 73 and the developing roller 72 can be more suppressed.

The thickness of a layer of the toner conveyed by the developing roller 72 is preferably 6 to 14 μm, more preferably 7 to 14 μm. By setting so, more toner conveyed by the developing roller 72 can be transferred to the photoconductive drum 37, wherefore there is less toner not to be transferred, sufficient image density can be obtained, and the selective transfer of the toner between the developing roller 72 and the photoconductive drum 37 can be more suppressed.

Further, f(mag) is higher than f(slv) and 2.5 kHz or higher.

The voltage applying means 90 preferably executes such a control as to apply an alternating-current voltage immediate before image development is started. By such a control, the scattering of the toner can be suppressed to a minimum level and a stable development performance can be maintained for a longer time. Further, the voltage applying means 90 executes such a control as to keep the potential difference between the developing roller 72 and the magnetic roller 73 constant for the time other than the development timing to maintain uniform image density, which is effective in collecting the toner on the developing roller 72 to the magnetic roller 73 without straining the toner.

Next, a developing device 100 according to the conventional technology, for example as disclosed in document D5, in which a toner supply bias voltage is not superposed on a development bias voltage and the toner supply bias voltage and the development bias voltage are individually applied is described as a comparative embodiment to be compared with the present invention.

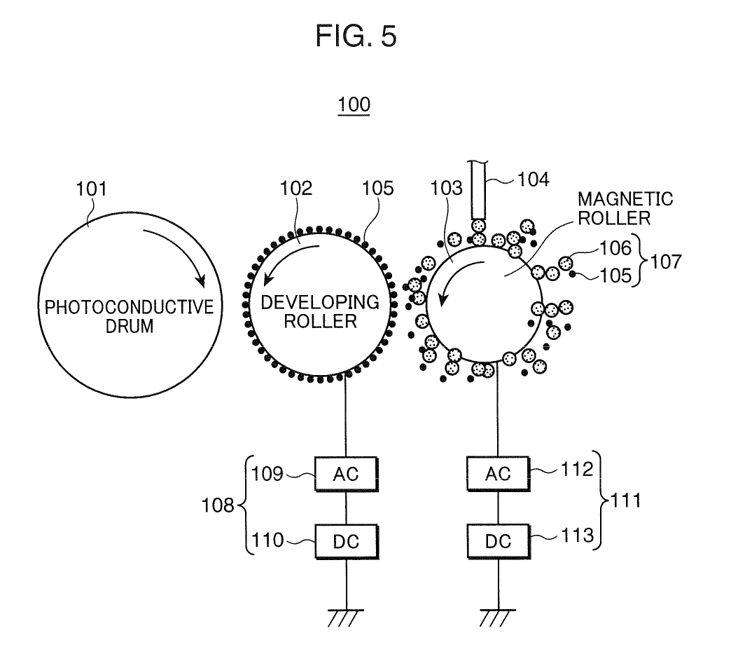

FIG. 5 is a schematic diagram showing the construction of the conventional developing device 100. The developing device 100 includes a developing roller 102 facing a photoconductive drum 101, a magnetic roller 103 facing the developing roller 102 and the like similar to the developing device 71 according to the embodiment of the present invention, and is similar to the developing device 71 except voltages to be applied to the developing roller 102 and the magnetic roller 103. Specifically, instead of including the above voltage applying means 90, the developing device 100 includes a development bias voltage applying means 108 for applying a development bias voltage to the developing roller 102 and a toner supply bias voltage applying means 111 for applying a toner supply bias voltage to the magnetic roller 103, the applying means 108, 111 being independent of each other. The development bias voltage applying means 108 includes an alternating-current power supply 109 for applying an alternating-current voltage having a rectangular waveform and a direct-current power supply 110 for applying a direct-current voltage. The toner supply bias voltage applying means 111 includes an alternating-current power supply 112 for applying an alternating-current voltage having the same frequency as the alternating-current voltage applied by the alternating-current power supply 109, a phase opposite to that of this alternating-current voltage and a duty ratio inverted from that of this alternating-current voltage, and a direct-current power supply 113 for applying a direct-current voltage.

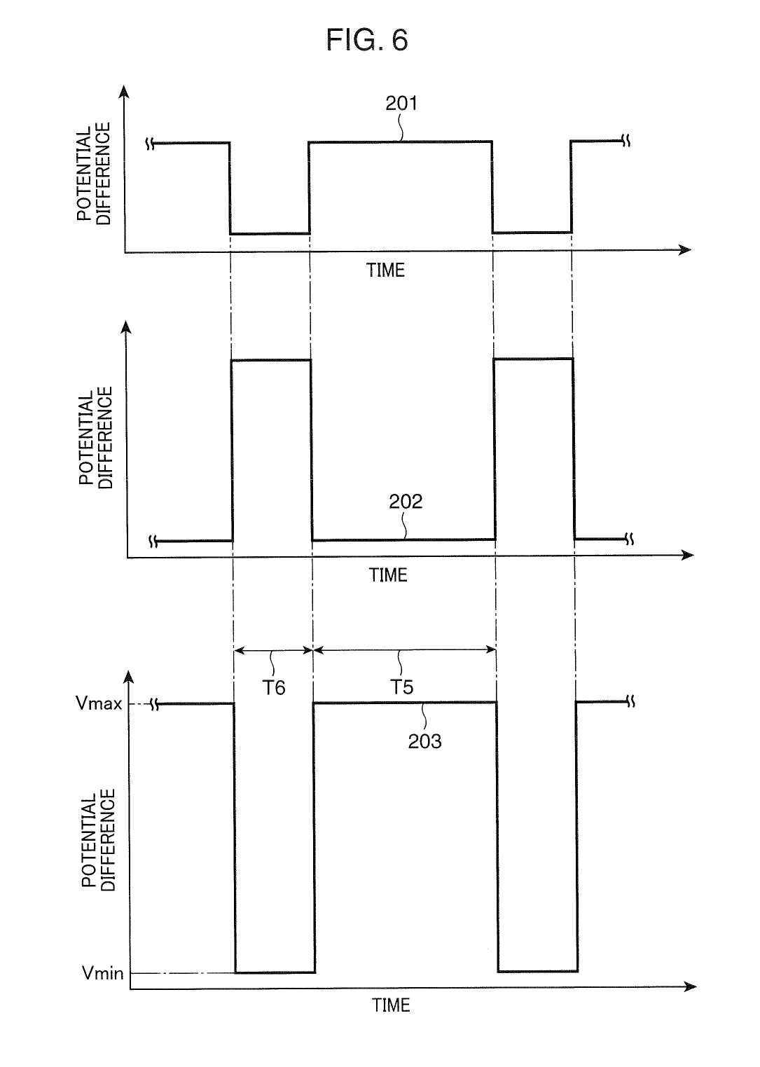

FIG. 6 is a waveform chart showing exemplary waveforms of voltages to be applied to the developing device 100 shown in FIG. 5. A waveform 201 shown in FIG. 6 is an exemplary waveform of the toner supply bias voltage to be applied to the magnetic roller 103. A waveform 202 shown in FIG. 6 is an exemplary waveform of the development bias voltage to be applied to the developing roller 102. A waveform 203 shown in FIG. 6 is an exemplary waveform of a voltage (potential difference) between the developing roller 102 and the magnetic roller 103.

By applying voltages as above, the developing device 100 can increase a voltage for transferring toner 105 from the magnetic roller 103 to the developing roller 102 (voltage between the developing roller 102 and the magnetic roller 103) without increasing a voltage between the photoconductive drum 101 and the developing roller 102 (development voltage) as shown in FIG. 6. This is thought to be due to the following.

In the developing device 100, the alternating-current voltage applied by the alternating-current power supply 112 of the toner supply bias voltage applying means 111 is superposed on the direct-current voltage applied by the direct-current power supply 113 of the toner supply bias voltage applying means 111 to obtain the toner supply bias voltage. At this time, the alternating-current voltage to be superposed is an alternating-current voltage corresponding to the alternating-current voltage applied by the alternating-current power supply 109 of the development bias voltage applying means 108 as shown by the waveforms 201, 202 of FIG. 6. In the developing device 100, the voltage for transferring the toner 105 from the magnetic roller 103 to the developing roller 102 is a combined waveform as shown by the waveform 203, which is a difference between the waveform 201 of the toner supply bias voltage and the waveform 202 of the development bias voltage. Accordingly, the developing device 100 can increase the voltage for transferring the toner 105 from the magnetic roller 103 to the developing roller 102 as shown by the waveform 203 of FIG. 6 without increasing the development bias voltage.

However, even in such a developing device 100, the voltage for transferring the toner 105 from the magnetic roller 103 to the developing roller 102 has to be controlled based on the relationship of the development bias voltage and the toner supply bias voltage, wherefore the selective transfer of the toner 105 cannot be sufficiently suppressed and there has been a likelihood of an occurrence of a problem as described below.

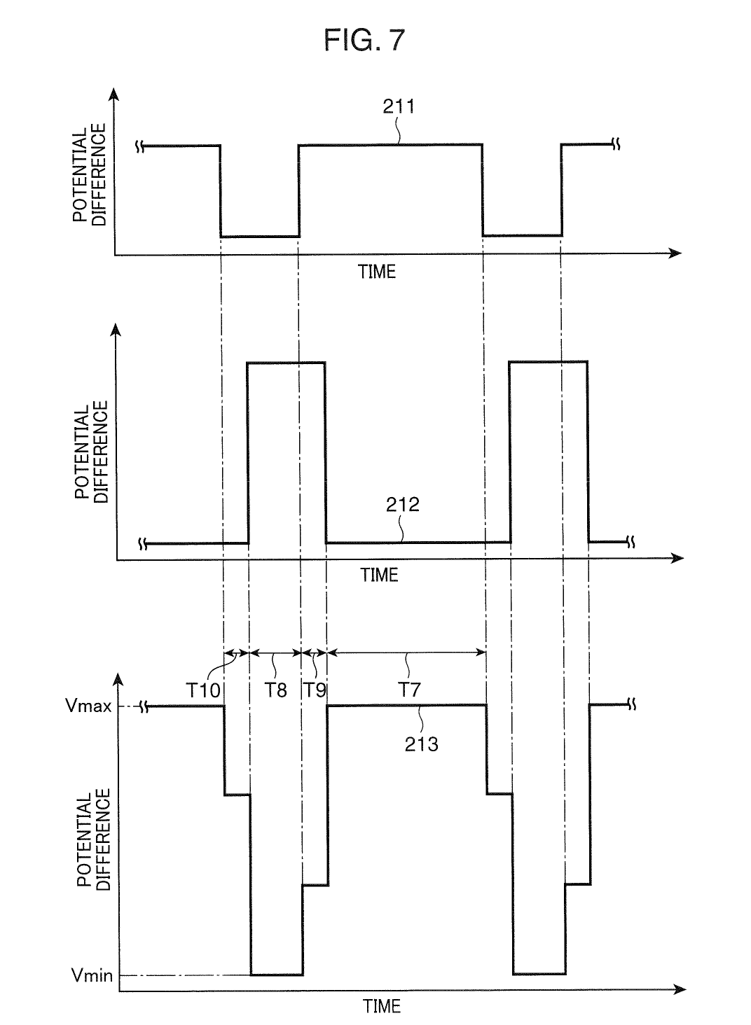

As shown in FIG.7 in the developing device 100, development efficiency decreases if the waveform of the development bias voltage and that of the toner supply bias voltage are deviated from preferred phases shown in FIG. 6. FIG. 7 is a waveform chart showing the case where the phases of the development bias voltage and the toner supply bias voltage are deviated from the preferred ones in the developing device 100 shown in FIG. 5. A waveform 211 shown in FIG. 7 is an exemplary waveform of the toner supply bias voltage to be applied to the magnetic roller 103. A waveform 212 shown in FIG. 7 is an exemplary waveform of the development bias voltage to be applied to the developing roller 102. A waveform 213 shown in FIG. 7 is an exemplary waveform of a voltage (potential difference) between the developing roller 102 and the magnetic roller 103.

If the development bias voltage and the toner supply bias voltage are in the phases as shown in FIG. 6, the developing device 100 has high development efficiency since one cycle is comprised of a period T5 during which a voltage Vmax for transferring the toner from the magnetic roller 103 to the developing roller 102 is applied and a period T6 during which a voltage Vmin for transferring the unnecessary toner back from the surface of the photoconductor surface. On the contrary, if the development bias voltage and the toner supply bias voltage slightly deviate from the relationship shown in FIG. 6, there exist periods T9, T10 during which voltages between Vmax and Vmin are applied in addition to a period T7 during which the voltage Vmax for transferring the toner from the magnetic roller 103 to the developing roller 102 is applied and a period T8 during which the voltage Vmin for pulling the unnecessary toner back from the surface of the photoconductor surface. In other words, the developing device 100 comes to have lower toner supply efficiency from the magnetic roller 103 to the developing roller 102 and lower collection efficiency of the toner, which was not used for image development, from the developing roller 102 to the magnetic roller 103. Accordingly, the developing device 100 need to rigorously control the development bias voltage and the toner supply bias voltage in order to maintain both high toner supply efficiency from the magnetic roller 103 to the developing roller 102 and high collection efficiency of the toner, which was not used for image development, from the developing roller 102 to the magnetic roller 103.

Since the potential difference between the developing roller 102 and the magnetic roller 103 depends on the combined waveform 203 of the toner supply bias voltage and the development bias voltage in the developing device 100 as described above, the sum of Duty(mag) and Duty(slv) is preferably 100. If this sum deviates from 100, both the toner supply efficiency from the magnetic roller 103 to the developing roller 102 and the collection efficiency of the toner, which was not used for image development, from the developing roller 102 to the magnetic roller 103 decrease. On the contrary, since the potential difference between the developing roller 72 and the magnetic roller 73 depends only on the toner supply bias voltage in the developing device 71 according to this embodiment, neither the toner supply efficiency from the magnetic roller 103 to the developing roller 102 nor the collection efficiency of the toner, which was not used for image development, from the developing roller 102 to the magnetic roller 103 decreases even if the sum of Duty(mag) and Duty(slv) is not 100. In other words, the developing device 71 according to this embodiment can set the sum of Duty(mag) and Duty(slv) to 100 or larger as described above. Accordingly, the toner supply bias voltage and the development bias voltage can be set based on the toner supply efficiency from the magnetic roller 73 to the developing roller 72 and the collection efficiency of the toner, which was not used for image development, from the developing roller 72 to the magnetic roller 73, wherefore a development bias for increasing the development efficiency can be applied to the developing roller 72 and the selective consumption of the toner can be supplied. Further, in the case of the developing device 71 according to this embodiment, the potential difference between the developing roller 72 and the magnetic roller 73 depends only on the toner supply bias voltage. Therefore, the toner can be more smoothly transferred from the magnetic roller 73 to the developing roller 72 by setting Vpp(mag) larger than Vpp(slv).

In the case of the conventional developing device 100, the phases of the toner supply bias voltage and the development bias voltage need to be regulated to be opposite to each other as shown in FIG. 6. However, in the case of the developing device 71 according to this embodiment, the phases of the toner supply bias voltage and the development bias voltage need not to be regulated as shown in FIGS. 4A and 4B.

The construction of the image forming apparatus 1 other than the developing device 71 is described below.

In the image forming apparatus 1, a special device such as a scraping blade for scraping the toner residual on the developing roller 72 after image development may or may not be provided above the circumferential surface. In the case of having no device for scraping off the toner, the image forming apparatus is, for example, constructed such that the magnetic brush on the magnetic roller 73 is held in contact with the toner layer on the developing roller 72 and the toner is collected and replaced by a brush effect brought about by a circumferential speed difference between the respective rollers. Since the two-component developer for forming the magnetic brush is replaced by the agitation of the paddle mixer 74 and the agitating mixer 75 in the image forming apparatus 1, the toner can be more easily collected and replaced. In such a case, the width of the magnetic brush is the width of a collection range for collecting the toner on the developing roller 72. Thus, by setting the width of the developing roller 72 shorter than that of the magnetic brush, an area where the toner cannot be collected can be reliably eliminated. By having the above construction, no toner adheres to the sleeve of the developing roller outside the area of the magnetic brush, thereby eliminating the toner scattering at the opposite ends of the developing roller.

The photoconductive drum 37 is preferably an amorphous silicon (a-Si) photoconductor. In such a photoconductor, if a photoconductive layer is thinned, there is a likelihood of decreasing saturation charge potential and reducing a withstand voltage to cause a dielectric breakdown. However, such a photoconductor has a characteristic that the potential of a latent image section (exposed section, image formation section) is as low as 20 V or even lower and that of a non-latent image section (unexposed section, non-image formation section) is about 350 V. Such a photoconductor also tends to improve charge density on the surface when a latent image is formed, thereby having a tendency to improve a development performance. This characteristic is particularly significant in the case where the thickness of the photoconductive layer is 25 μm or smaller, more preferably 20 μm or smaller in the a-Si photoconductor having a dielectric constant of as high as about 10. For example, a photoconductive drum having a diameter of 30 mm is used as the photoconductive drum 37.

If a positively charged organic photoconductor (OPC) is used as the photoconductive drum 37, it is particularly important to set the thickness of a photoconductive layer to 25 μm or larger and increase an added amount of a charge generating material in order to set a residual potential to 100 V or less. Particularly, an OPC having a single layer structure is advantageous since the electric charge generating material is added in the photoconductive layer and, hence, sensitivity changes a little even if the thickness of the photoconductive layer decreases. Even in this case, the voltage value of the direct-current voltage of the development bias voltage is preferably 400 V or smaller, more preferably 300 V or smaller to prevent the action of a strong electric field on the toner.

Any ordinary carrier can be used as the carrier contained in the two-component developer without being particularly limited. Since the carrier functions to collect and supply the toner, it is preferably a fine carrier having a volume resistivity of 10⁶ to 10¹³ Ωcm and an average particle diameter of 50 μm or smaller. For example, a carrier having a volume resistivity of 10¹⁰ Ωcm, a saturation magnetization of 65 emu/g and an average particle diameter of 45 μm is used. It should be noted that the saturation magnetization can be measured on the condition that a magnetic field is 79.6 kA/m(1 kOe) using a VSM-P7 manufactured by Toei Industry Co., Ltd. If the volume resistivity is 10⁶ to 10¹³ Ωcm, it is possible to scrape off the toner firmly electrostatically adhering in a nip between the developing roller 72 and the magnetic roller 73 by the magnetic brush and to supply the toner necessary for image development. The use of a fine carrier having an average particle diameter of 50 μm or smaller is preferable since the surface area of the carrier is increase d to increase contact points with the toner.

The circumferential speeds of the photoconductive drum 37 and the developing roller 72 are, for example, set to 300, 450 mm/sec respectively, and a circumferential speed ratio of the developing roller 72 to the photoconductive drum 37 (developing roller circumferential speed/photoconductive drum circumferential speed) is, for example, 1.5.

A circumferential speed ratio of the magnetic roller 73 and the developing roller 72 (magnetic roller circumferential speed/developing roller circumferential speed) is preferably 1.0 to 2.0 and, for example, set to 1.5. At this time, the circumferential speed of the magnetic roller 73 is, for example, set to 675 mm/sec. By setting so, the replacement of the two-component developer can be promoted, whereby the toner on the developing roller 72 can be collected and the two-component developer having a suitable toner density set can be supplied to the developing roller 72. Therefore, a uniform toner layer can be formed.

A gap between the magnetic roller 73 and the developing roller 72 is preferably 100 to 1000 m, more preferably 150 to 500 μm. This gap is, for example, set to 350 μm. Further, a gap between the developing roller 72 and the photoconductive drum 37 (development gap) is preferably 100 to 1000 μm, more preferably 150 to 500 μm. This development gap is, for example, set to 200 μm. There is a possibility that leakage and imaging pitch variation occur if the gap between the magnetic roller 73 and the developing roller 72 and the development gap are too small, whereas there is a possibility that the development performance decreases if these gaps are too large.

Although the image forming apparatus is described, taking the tandem image forming apparatus as an example in the above embodiment, the present invention is applicable to any electrophotographic image forming apparatus and is not limited to tandem image forming apparatuses. The developing device according to this embodiment can suppress an occurrence of image nonuniformity caused by a development gap variation. Thus, a small-size tandem image forming apparatus provided with such a developing device is preferable in being able to suppress the image nonuniformity caused by the development gap variation, which is likely to occur in the small-size tandem image forming apparatus. Although the color printer is described as an example of the image forming apparatus according to this embodiment, the image forming apparatus may be, for example, a copier, a facsimile machine or a complex machine. Further, although the photoconductive drum as a drum-shaped photoconductor is described as an example of the image bearing member, a belt-shaped photoconductor, a sheet-like photoconductor or the like may be used without being limited to the above.

### EXAMPLES

The color printer 1 according to this embodiment is described below by way of an example.

Examples 1 to 6 and Comparative Example 1 are set as follows.

Photoconductive drum 37: a-Si drum, 30 mm in diameter and 300 mm/sec in circumferential speed

Developing roller 72: 20 mm in diameter and 450 mm/sec in circumferential speed

Magnetic roller 73: 25 mm in diameter and 675 mm/sec in circumferential speed

Development gap: 200 μm

Gap between the magnetic roller 73 and the developing device 72: 350 μm

Toner supply bias voltage: Vdc(mag)=400V, f(mag)=2.7 kHz, Vpp(mag) and Duty(mag) as shown in Table-1.

Development bias voltage: Vdc(slv)=300 V, f(slv)=2.7 kHz, Vpp(slv) and Duty(slv) as shown in Table-1

Toner: 6.5 μm in volume average particle diameter, 23.5% in CV value of an initial number distribution, CV(mag), CV(slv) and CV(drum) as shown in Table-1.

The volume average particle diameter and the CV value are values outputted from a Multicizer III manufactured by Beckman Coulter, Inc. Specifically, the particle diameters, the number and the like of the toner particles were measured using the Multicizer III with an aperture diameter of 100 μm in a measurement range of 2 to 60 μm, and the volume average particle diameter and the CV value were calculated from these measurement values.

Carrier: 45 μm in weight average particle diameter, 65 emu/g in saturation magnetization.

It should be noted that the saturation magnetization is a value measured on the condition that a magnetic field was 79.6 kA/m(1 kOe) using a VSM-P7 manufactured by Toei Industry Co., Ltd.

TABLE 1

| | CV(drum) | CV(slv) | CV(mag) | | | | Vpp(slv) | Vpp(mag) | Duty(slv) | Duty(mag) |
|---|---|---|---|---|---|---|---|---|---|---|
| | [%] | [%] | [%] | A | B | C | [kV] | [kV] | [%] | [%] |
| Example 1 | 22.0 | 22.6 | 23.5 | 0.9 | 0.6 | 1.5 | 1.6 | 2.8 | 50 | 65 |
| Example 2 | 20.1 | 20.6 | 23.5 | 2.9 | 0.5 | 3.4 | 1.6 | 1.6 | 50 | 65 |
| Example 3 | 21.5 | 22.6 | 23.5 | 0.9 | 1.1 | 2.0 | 1.6 | 2.8 | 40 | 65 |
| Example 4 | 20.5 | 23.0 | 23.5 | 0.5 | 2.5 | 3.0 | 1.6 | 2.8 | 35 | 70 |
| Example 5 | 20.0 | 23.0 | 23.5 | 0.5 | 3.0 | 3.5 | 1.6 | 2.8 | 30 | 70 |
| Example 6 | 17.6 | 18.8 | 23.5 | 4.7 | 1.2 | 5.9 | 1.6 | 1.6 | 45 | 50 |
| Com. Exa. 1 | 14.3 | 17.5 | 23.5 | 6.0 | 3.2 | 9.2 | 1.6 | 1.6 | 55 | 40 |

A: Absolute value of difference between CV(slv) and CV(mag)[%]
B: Absolute value of difference between CV(drum) and CV(slv)[%]
C: Absolute value of difference between CV(drum) and CV(mag)[%]

The following evaluations were made for the image forming apparatuses according to Examples 1 to 6 and Comparative Example 1 and the result thereof is shown in Table-2.

### (Toner Layer Thickness)

Using a LASER SCAN DIAMETER LS-3100 manufactured by Keyence Corporation, the diameter d₁ of the developing device 72 carrying the toner 81 and diameter d₂ of the developing device 72 before carrying the toner 81 were measured. Then half of the difference between diameter d₁ and diameter d₂[(d₁−d₂)/2] was calculated. The calculated value [(d₁−d₂)/2] is the thickness of a layer of the toner conveyed by the developing roller 72.

### (Image Nonuniformity A)

The luminance P of a printed sheet was measured as follows and image nonuniformity A was calculated from the measurement result.

### <Method for Measuring the Image Nonuniformity>

A halftone image having a tone value of 25% (600 dpi) was formed on a sheet based on an image data scanned at 3000 dpi using a color scanner ES8500 manufactured by Seiko Epson Corporation and luminance Pi was measured at a plurality of positions of this sheet.

It should be noted that the luminance Pi was measured using a Dot Analyzer DA-6000 manufactured by Oji Scientific Instruments, wherein the luminance of solid parts was Pmax and that of blank parts was Pmin.

Subsequently, the data of the luminance Pi is converted into density data Di in accordance with the following equation (2). Upon the conversion into the density data, relative densities of Pi with respect to Pmax and Pmin are calculated and corrected by taking a logarithm since the image nonuniformity becomes more difficult to see (difficult to appear in luminance) as density increases.

Di=Log[(Pmax−Pi)/Pmin] (2)

Finally, the image nonuniformity is calculated by substituting the calculated Di into the following equations (3) to (5).

An average value of Di is calculated in accordance with the following equation (3).

$$Da = \frac{1}{N} {\sum }_{i = 1}^{N} Di \qquad ( 3 )$$

Next, “deviations” from Da are calculated in accordance with the following equation (4).

$${σ}_{D} = \sqrt{\frac{1}{N} {\sum }_{i = 1}^{N} {( Di - Da )}^{2}} \qquad ( 4 )$$

Then, the image nonuniformity A is calculated in accordance with the following equation (5) to be used as an index for image nonuniformity evaluation.

A=σ_{D}/Da (5)

### (Image Density ID)

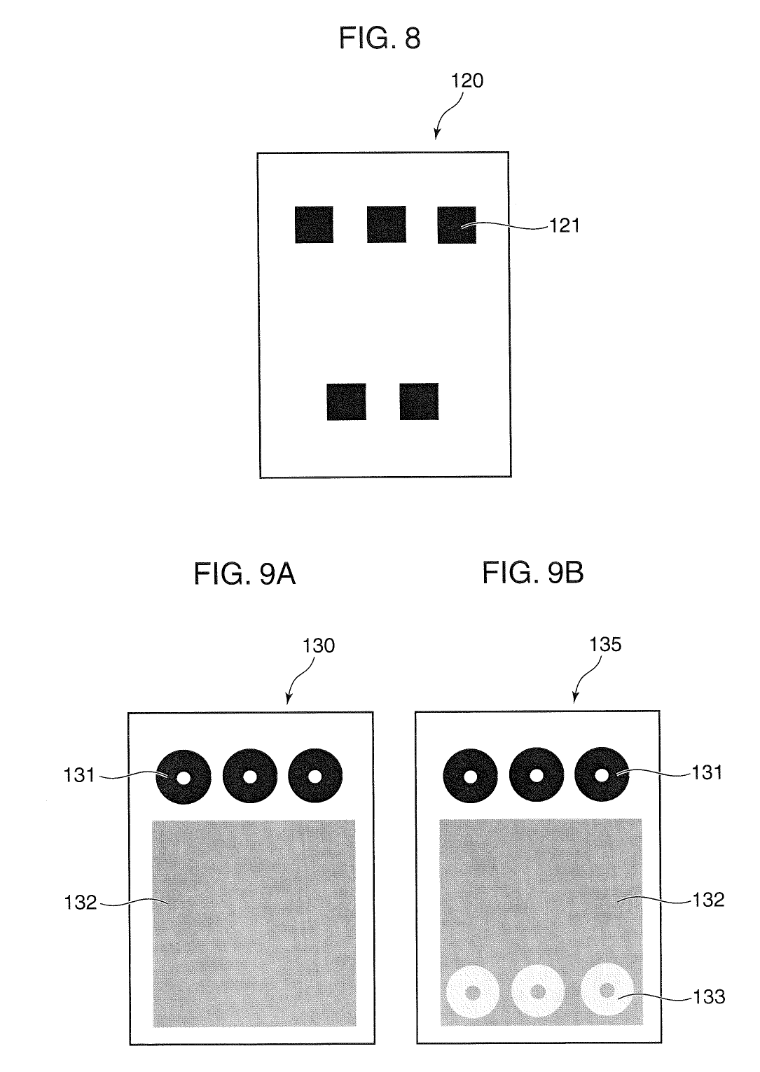

First of all, an evaluation image shown in FIG. 8 was outputted. FIG. 8 shows an example of an evaluation image 120 used for the evaluation of the image density ID. This evaluation image 120 is an image having solid parts 121 at five positions as shown in FIG. 8.

Next, the image densities ID of the solid parts 121 at the five positions were respectively measured and evaluation was made with the following criteria using an average value of the measured image densities as the image density for this evaluation. It should be noted that the image densities ID were measured using a GretagMacbeth portable reflection densitometer RD-19 manufactured by Sakata Inc Corporation.

Permissible: image density of 1.3 or higher

Impermissible: image density of below 1.3

### (Ghost)

First of all, the following evaluation image was outputted. FIGS. 9A and 9B are diagrams showing a ghost evaluation. FIG. 9A shows an example of an evaluation image 130 used for the ghost evaluation, and FIG. 9B shows an example of an output image 135 when a ghost occurred. This evaluation image 130 is an image having solid portions 131 with a tone value of 100% at three positions as shown in FIG. 9A and a halftone image 132 with a tone value of 10% or 25% at a rear side with respect to a printing direction.

Subsequently, it is judged by the eyes whether any ghost (ghost image) 133 as shown in FIG. 9B is formed in the halftone image 132 of the output image and evaluation was made with the following criteria.

Good: No ghost 133 is confirmed even the halftone image 132 has a tone value of 10%.

Satisfactory: The ghost 133 is slightly confirmed if the halftone image 132 has a tone value of 10%, but no ghost 133 is confirmed if the halftone image 132 has a tone value of 25%.

Permissible: The ghost 133 is slightly confirmed even if the halftone image 132 has a tone value of 25%.

Impermissible: The ghost 133 is clearly confirmed even if the halftone image 132 has a tone value of 25%.

### (CV(mag) After Making 10000 Prints>

CV(mag) was measured after 10000 images with a coverage rate of 6% were printed.

TABLE 2

| | A | B | C | | D | E |
|---|---|---|---|---|---|---|
| Example 1 | 11.5 | 0.12 | 1.415 | ∘ | Good | 25.4 |
| Example 2 | 8.8 | 0.12 | 1.365 | ∘ | Satisfactory | 27.2 |
| Example 3 | 10.0 | 0.12 | 1.401 | ∘ | Good | 26.1 |
| Example 4 | 12.0 | 0.132 | 1.374 | ∘ | Good | 26.0 |
| Example 5 | 12.0 | 0.145 | 1.324 | ∘ | Good | 26.5 |
| Example 6 | 7.5 | 0.125 | 1.345 | ∘ | Permissible | 28.1 |
| Com. Exa. 1 | 6.8 | 0.188 | 1.295 | x | Impermissible | 32.1 |

A: Toner layer thickness[μm]
B: Image nonuniformity A
C: Image density ID (initial stage)
D: Ghost
E: CV(mag)[%] (after making 10000 prints)
∘: Permissible
x: Impermissible

As can be understood from Table-2, if the absolute value of the difference between CV(slv) and CV(mag) is within 5% (Examples 1 to 6), occurrences of the image nonuniformity and the ghost can be suppressed even after making 10000 prints to exhibit a stable development performance over a long term despite the high image density ID at the initial stage. Thus, in Examples 1 to 6, high-quality images can be formed over a long term. Contrary to this, if the absolute value of the difference between CV(slv) and CV(mag) is larger than 5% (Comparative Example 1), occurrences of the image nonuniformity and the ghost cannot be suppressed after making 10000 prints despite the low image density ID at the initial stage.

The relationship between CV(slv) and CV(mag) similarly applies in the relationship between CV(drum) and CV(mag). Specifically, if the absolute value of the difference between CV(drum) and CV(mag) is within 6% (Examples 1 to 6), occurrences of the image nonuniformity and the ghost can be suppressed even after making 10000 prints to exhibit a stable development performance over a long term despite the high image density ID at the initial stage. Thus, in Examples 1 to 6, high-quality images can be formed over a long term. Contrary to this, if the absolute value of the difference between CV(drum) and CV(mag) is larger than 6% (Comparative Example 1), occurrences of the image nonuniformity and the ghost cannot be suppressed after making 10000 prints despite the low image density ID at the initial stage.

As compared to Comparative Example 1, an increase of CV(mag) is suppressed even after making 10000 prints in Examples 1 to 6. This also indicates that the particle size distribution of the toner in the developing device changes a little and a stable development performance can be exhibited over a long term.

The comparison of Examples 1 to 6 and Comparative Example 1 reveals that the absolute value of the difference between CV(drum) and CV(slv) being within 3% can contribute to the stable development performance over a long term.

The case where the sum of Duty(slv) and Duty(mag) is larger than 100 (Examples 1 to 4) is more preferable than the case where the sum of Duty(slv) and Duty(mag) is equal to or smaller than 100 (Examples 5, 6) in being able to more suppress the occurrences of the image nonuniformity and the ghost.

As described in detail above, an image forming apparatus according to one aspect of the present invention comprises an image bearing member to have an electrostatic latent image formed thereon; a developing roller arranged to face the image bearing member and adapted to carry and convey a toner on the outer surface thereof; a magnetic roller for carrying and conveying a two-component developer containing a toner and a carrier; a first bias voltage applying device for applying a toner supply bias voltage to the magnetic roller to transfer the toner in the two-component developer conveyed by the magnetic roller to the outer surface of the developing roller; and a second bias voltage applying device for applying a development bias voltage to the developing roller to cause the toner conveyed by the developing roller to fly to the outer surface of the image bearing member, thereby developing the electrostatic latent image formed beforehand on the outer surface of the image bearing member into a toner image for the formation of an image, wherein an absolute value of a difference between a first coefficient of variation in a number distribution of the particle diameter of the toner carried on the developing roller and a second coefficient of variation in a number distribution of the particle diameter of the toner in the two-component developer carried on the magnetic roller is within 5%; and an absolute value of a difference between a third coefficient of variation in a number distribution of the particle diameter of the toner of the toner image developed on the outer surface of the image bearing member and the second coefficient of variation is within 6%.

According to this construction, the selective transfer of the toner is suppressed between the magnetic roller and the developing roller and a toner having specified particle diameter out of the toner in the two-component developer carried on the magnetic roller are less likely to preferentially transfer to the developing roller. Further, the selective transfer of the toner is also suppressed between the magnetic roller and the image bearing member and the toner having specified particle diameter out of the toner in the two-component developer carried on the magnetic roller are less likely to be preferentially used for image development. Thus, the particle diameter distribution of the toner in the developing device changes a little in this image forming apparatus even if image formations are performed, wherefore a stable development performance can be exhibited over a long term and high-quality images can be stably formed over a long term.

In the above image forming apparatus, the absolute value of the difference between the first and third coefficients of variation is within 3%. According to this construction, the toner having specified particle diameter out of the toner carried on the developing roller are less likely to be preferentially used for image development and the selective transfer of the toner is also suppressed between the image bearing member and the developing roller. Therefore, the particle diameter distribution of the toner in the developing device changes a little in this image forming apparatus even if image formations are performed, wherefore a stable development performance can be exhibited over a long term and high-quality images can be stably formed over a long term.

The toner supply bias voltage is preferably superposed on the development bias voltage. By doing so, the transfer of the toner from the magnetic roller to the developing roller hardly depends on the development bias voltage, but depends on the toner supply bias voltage. On the other hand, the transfer of the toner from the developing roller to the image bearing member hardly depends on the toner supply bias voltage, but depends on the development bias voltage. In other words, the selective transfer of the toner between the magnetic roller and the developing roller and the one between the developing roller and the image bearing member can be respectively individually optimized by individually controlling the toner supply bias voltage and the development bias voltage. Therefore, a construction capable of suppressing both of the above two selective transfers of the toner can be easily realized and high-quality images can be stably formed over a longer term.

In the image forming apparatus in which the toner supply bias voltage is superposed on the development bias voltage, a voltage difference between the maximum and minimum values of the toner supply bias voltage is preferably larger than a voltage difference between the maximum and minimum values of the development bias voltage. Since the transfer of the toner from the magnetic roller to the developing roller depends on the toner supply bias voltage, the toner of the two-component toner carried on the magnetic roller can be more smoothly transferred by having the above construction. Accordingly, the selective transfer of the toner between the magnetic roller and the developing roller can be more suppressed. Therefore, high-quality images can be stably formed over a longer term.

The sum of positive duty ratios of the toner supply bias voltage and the development bias voltage is preferably larger than 100. According to this construction, both a period during which the toner supply bias voltage is applied to transfer the toner of the two-component developer on the magnetic roller to the developing roller and a period during which the development bias voltage is applied to transfer the toner on the developing roller to the image bearing member can be extended. Since the toner can be effectively transferred, both of the two selective transfers of the toner can be more suppressed.

The positive duty ratio of the toner supply bias voltage is preferably larger than that of the development bias voltage. According to this construction, the toner can be made less likely to transfer from the developing roller to the image bearing member and the toner of the two-component toner carried on the magnetic roller can be more smoothly transferred. Therefore, the selective transfer of the toner between the magnetic roller and the developing roller can be more suppressed.

The thickness of a layer of the toner conveyed by the developing roller is preferably 6 to 14 μm. By setting so, more toner conveyed by the developing roller can be transferred to the image bearing member, wherefore the selective transfer of the toner between the developing roller and the image bearing member can be more suppressed.

The developing roller is preferably formed with a magnetic pole at a position facing the magnetic roller. According to this construction, the toner on the developing roller not used for image development can be more easily collected since a magnetic brush made of the two-component toner between the developing roller and the magnetic roller can be robust. Since less toner not used for image development is, hence, accumulated on the developing roller, a hysteresis can be suppressed and a higher development performance can be exhibited. Since the robust magnetic brush is formed, the selective transfer of the toner between the magnetic roller and the developing roller can be more suppressed.

Accordingly, high-quality images can be stably formed over a longer term since the particle diameter distribution of the toner changes less in the developing device even if image formations are performed.

A developing device according another aspect of the present invention comprises a developing roller arranged to face an image bearing member to have an electrostatic latent image formed thereon and adapted to carry and convey a toner on the outer surface thereof; a magnetic roller for carrying and conveying a two-component developer containing a toner and a carrier; a first bias voltage applying device for applying a toner supply bias voltage to the magnetic roller to transfer the toner in the two-component developer conveyed by the magnetic roller to the outer surface of the developing roller; and a second bias voltage applying device for applying a development bias voltage to the developing roller to cause the toner conveyed by the developing roller to fly to the outer surface of the image bearing member, thereby developing the electrostatic latent image formed beforehand on the outer surface of the image bearing member into a toner image, wherein an absolute value of a difference between a first coefficient of variation in a number distribution of the particle diameter of the toner carried on the developing roller and a second coefficient of variation in a number distribution of the particle diameter of the toner in the two-component developer carried on the magnetic roller is within 5%.

According to this construction, a toner having specified particle diameter out of the toner in the two-component developer carried on the magnetic roller are less likely to preferentially transfer to the developing roller, thereby suppressing the selective transfer of the toner between the magnetic roller and the developing roller. Thus, the particle diameter distribution of the toner in the developing device changes a little in this developing device even if image formations are performed, wherefore a stable development performance can be exhibited over a long term.

A developing device according to still another aspect of the present invention comprises a developing roller arranged to face an image bearing member and adapted to carry and convey a toner on the outer surface thereof; a magnetic roller for carrying and conveying a two-component developer containing a toner and a carrier; a first bias voltage applying device for applying a toner supply bias voltage to the magnetic roller to transfer the toner in the two-component developer conveyed by the magnetic roller to the outer surface of the developing roller; and a second bias voltage applying device for applying a development bias voltage to the developing roller to cause the toner conveyed by the developing roller to fly to the outer surface of the image bearing member, thereby developing the electrostatic latent image formed beforehand on the outer surface of the image bearing member into a toner image, wherein an absolute value of a difference between a third coefficient of variation in a number distribution of the particle diameter of the toner of the toner image developed on the outer surface of the image bearing member and a second coefficient of variation in a number distribution of the particle diameter of the toner in the two-component developer carried on the magnetic roller is within 6%.

According to this construction, the selective transfer of the toner is suppressed between the magnetic roller and the image bearing member and a toner having specified particle diameter out of the toner in the two-component developer carried on the magnetic roller are less likely to be preferentially used for image development. Thus, the particle diameter distribution of the toner in the developing device changes a little in this developing device even if image formations are performed, wherefore a stable development performance can be exhibited over a long term.

This application is based on patent application Nos. 2007-139455 and 2007-139456 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to be embraced by the claims.

What is claimed is:

1. An image forming apparatus, comprising:
an image bearing member to have an electrostatic latent image formed thereon;
a developing roller arranged to face the image bearing member and adapted to carry and convey a toner on the outer surface thereof;
a magnetic roller for carrying and conveying a two-component developer containing a toner and a carrier;
a first bias voltage applying device for applying a toner supply bias voltage to the magnetic roller to transfer the toner in the two-component developer conveyed by the magnetic roller to the outer surface of the developing roller; and
a second bias voltage applying device for applying a development bias voltage to the developing roller to cause the toner conveyed by the developing roller to fly to the outer surface of the image bearing member, thereby developing the electrostatic latent image formed beforehand on the outer surface of the image bearing member into a toner image for the formation of an image,
wherein:
an absolute value of a difference between a first coefficient of variation in a number distribution of the particle diameter of the toner carried on the developing roller and a second coefficient of variation in a number distribution of the particle diameter of the toner in the two-component developer carried on the magnetic roller is within 5%; and
an absolute value of a difference between a third coefficient of variation in a number distribution of the particle diameter of the toner of the toner image developed on the outer surface of the image bearing member and the second coefficient of variation is within 6%.

2. An image forming apparatus according to claim 1, wherein the absolute value of the difference between the first and third coefficients of variation is within 3%.

3. An image forming apparatus according to claim 1, wherein the toner supply bias voltage is superposed on the development bias voltage.

4. An image forming apparatus according to claim 3, wherein a voltage difference between the maximum and minimum values of the toner supply bias voltage is larger than a voltage difference between the maximum and minimum values of the development bias voltage.

5. An image forming apparatus according to claim 1, wherein the sum of positive duty ratios of the toner supply bias voltage and the development bias voltage is larger than 100.

6. An image forming apparatus according to claim 1, wherein a positive duty ratio of the toner supply bias voltage is larger than that of the development bias voltage.

7. An image forming apparatus according to claim 1, wherein the thickness of a layer of the toner conveyed by the developing roller is 6 to 14 μm.

8. An image forming apparatus according to claim 1, wherein the developing roller is formed with a magnetic pole at a position facing the magnetic roller.

9. A developing device, comprising:
a developing roller arranged to face an image bearing member to have an electrostatic latent image formed thereon and adapted to carry and convey a toner on the outer surface thereof;
a magnetic roller for carrying and conveying a two-component developer containing a toner and a carrier;
a first bias voltage applying device for applying a toner supply bias voltage to the magnetic roller to transfer the toner in the two-component developer conveyed by the magnetic roller to the outer surface of the developing roller; and
a second bias voltage applying device for applying a development bias voltage to the developing roller to cause the toner conveyed by the developing roller to fly to the outer surface of the image bearing member, thereby developing the electrostatic latent image formed beforehand on the outer surface of the image bearing member into a toner image,
wherein an absolute value of a difference between a first coefficient of variation in a number distribution of the particle diameter of the toner carried on the developing roller and a second coefficient of variation in a number distribution of the particle diameter of the toner in the two-component developer carried on the magnetic roller is within 5%.

10. A developing device, comprising:
a developing roller arranged to face an image bearing member and adapted to carry and convey a toner on the outer surface thereof;
a magnetic roller for carrying and conveying a two-component developer containing a toner and a carrier;
a first bias voltage applying device for applying a toner supply bias voltage to the magnetic roller to transfer the toner in the two-component developer conveyed by the magnetic roller to the outer surface of the developing roller; and
a second bias voltage applying device for applying a development bias voltage to the developing roller to cause the toner conveyed by the developing roller to fly to the outer surface of the image bearing member, thereby developing the electrostatic latent image formed beforehand on the outer surface of the image bearing member into a toner image,
wherein an absolute value of a difference between a third coefficient of variation in a number distribution of the particle diameter of the toner of the toner image developed on the outer surface of the image bearing member and a second coefficient of variation in a number distribution of the particle diameter of the toner in the two-component developer carried on the magnetic roller is within 6%.
